(19) United States
(12) Patent Application Publication
(10) Pub. No.: US 2024/0020711 A1
(43) Pub. Date: Jan. 18, 2024

(54) METHODS AND SYSTEMS FOR CUSTOMER ACCOUNTS ASSOCIATION IN MULTILINGUAL ENVIRONMENTS

(71) Applicant: Caterpillar Inc., Peoria, IL (US)

(72) Inventors: Mark G. Gobrial, Washington, IL (US); Tianyi Li, Chicago, IL (US); Daniela Radakovic, Chicago, IL (US); Toby Tennent, Chicago, IL (US)

(21) Appl. No.: 17/867,479

(22) Filed: Jul. 18, 2022

(51) Int. Cl. G06Q 30/02

(52) U.S. Cl. CPC G06Q 30/0201

(57) ABSTRACT

A technique is directed to methods and systems for customer accounts association in multilingual environments. The data aggregation system can utilize a machine learning-based algorithm that identifies all the accounts belonging to the same customer based on relevant account information. Inputs can include customer name, customer address, email, phone number, type of industry, or type of fleet. The system utilizes feature creation and a coarse pass to identify likely account pairs, perform account association by preparing an input core dataset, and update the core dataset at a predefined time interval with identified new or changed records.

### BACKGROUND

Generally, the association of all accounts belonging to the same customer is impeded by the use of incorrect, partial, and/or abbreviated relevant account information such as names, customer addresses, types of industry, and types of fleets. The format and standards of the data are often not consistent, as data is entered by a variety of people from different organizations. Software engines for automated association process have difficulty processing incorrect, partial and/or abbreviated information due to poorly or not documented descriptors. Languages such as Chinese, Japanese, and Korean, can add even more complexities. Large customers frequently use different service providers and multiple customer accounts. This results in a fragmented view of the customer for original equipment manufacturer (OEM) that supplies goods to the same customer through multiple service providers. Companies have implemented various techniques to solve this problem. For example, U.S. Patent Publication No. US20200311707A1 describes a method for mapping in-store transactions associated with traceable tenders to valid customer profiles. However, this method is only directed to associating a transaction with a customer based on attributes identified in the customer profile. Additionally, U.S. Patent Publication No. US20180191644A1 describes a method for providing interactive transaction returns within a retailer network. However, this method is only directed to identifying information for a customer from a transaction and matching it with customer profiles.

### SUMMARY

Other aspects will appear hereinafter. The features described herein can be used separately or together, or in various combinations of one or more of them.

### BRIEF DESCRIPTION OF THE DRAWINGS

FIG. 1 is a flow diagram illustrating a process used in some implementations for creating and training a system for customer accounts association in multilingual environments.

FIG. 2 is a flow diagram illustrating a process used in some implementations for applying a system for customer accounts association in multilingual environments.

FIG. 3 is a diagram illustrating a group creation process according to the present disclosure.

FIG. 4 is a block diagram illustrating an overview of devices on which some implementations can operate.

FIG. 5 is a block diagram illustrating an overview of an environment in which some implementations can operate.

FIG. 6 is a block diagram illustrating components which in some implementations can be used in a system employing the disclosed technology.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to methods and systems for customer accounts association in multilingual environments. The association of all accounts belonging to the same customer can be impeded by incorrect, partial, and/or abbreviated relevant account information such as names, customer addresses, types of industry, and types of fleets. Aggregated customer data from different service providers can allow an original equipment manufacturer (OEM) to better support customers and organize targeted marketing campaigns for a better overall customer experience. In the case that service providers share their customer data with the OEM, the OEM would benefit from aggregating the data from different service providers and aligning it to the customer to build a better and more complete picture of the customer. This will allow the OEM to better support customers, improve the customer experience, and increase aftermarket profits for both OEM and service providers.

The data aggregation system can utilize a machine learning-based algorithm that identifies all the accounts belonging to the same customer based on relevant account information. Inputs can include customer name, customer address, email, phone number, type of industry, type of fleet, etc. The system utilizes feature creation and a coarse pass to identify likely account pairs. The data aggregation system can perform account association by preparing an input core dataset and updating the core dataset at a predefined time interval with identified new or changed records. The system can reduce the number of record comparisons from the core dataset by performing at least a 2-step string similarity procedure (e.g., execution of a cosine similarity procedure and a Levenshtein distance) with the aim to increase the speed of the association process. Potential matches are identified based on a list of features with corresponding values of distance metrics. The system can execute a binary classifier algorithm (e.g., a gradient boosting machine learning algorithm) having the potential matches as an input. In some implementations, the system generates a transitivity graph based on the binary classifier output and the graph is converted into account groups based on a predefined threshold.

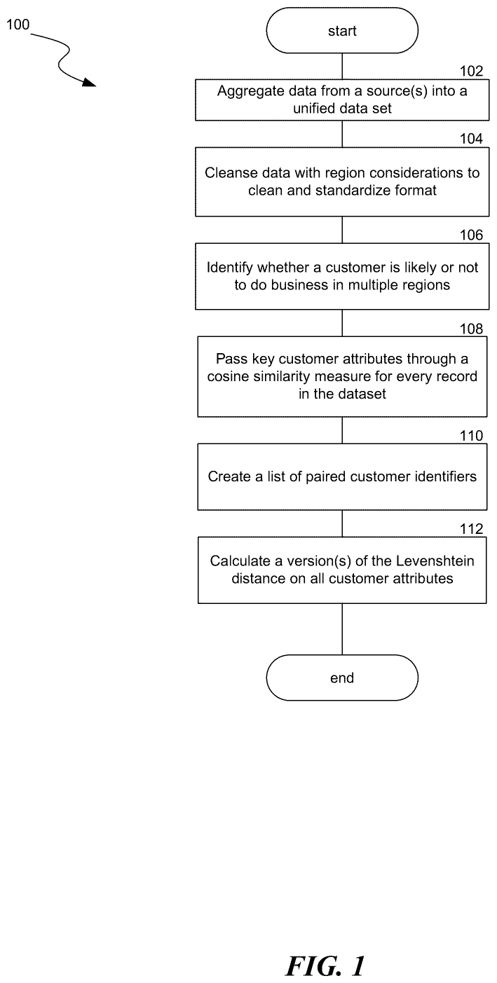

Several implementations are discussed below in more detail in reference to the figures. FIG. 1 is a flow diagram illustrating a process 100 used in some implementations for creating and training a system for customer accounts association in multilingual environments. At step 102, process 100 aggregates the input data from the sources of customer information into an input core dataset (unified dataset). Input data can include records of customer name, customer address, email, phone number, type of industry, type of fleet, etc. Process 100 can group and store similar type information together. For example, storing data describing the location information of the company together. Process 100 can identify new or changed records and update the core dataset, continuously, periodically, or at a predefined time interval with the new or changed records.

At step 104, process 100 cleanses the data with region specific logic to standardize the data across multiple regions. Cleansing and standardizing the data can prevent misleading results in the subsequent feature creation steps of process 100. For example, address information does not arrive consistently across regions, such as the order of country, zip code, and street address varies between countries. Process 100 can parse the regional data to a consistent format and structure that can be used for matching the data with other data. Since the matching process can be sensitive to the length of the strings, process 100 can generate a set of abbreviations of commonly used strings. If an example of “Jones Construction Services” and “James Construction Services”, there is similarity between these two strings (e.g., “construction services”), though a human can intuitively know the two strings are not related to the same organization. As such the abbreviation of common strings, such as “Construction Services” provides a pseudo penalty to the matching of longer common strings.

At step 106, process 100 identifies whether a customer is likely or not to perform business in multiple regions by using regionally based logic gained through exploratory data analysis, as well as discussions with individuals from local regions. Process 100 can utilize this information when matching metrics, to save computational resources as well as avoid creating false positive matches.

Once the data has been prepared, process 100 can calculate the distance/similarity metrics. Due to the volume of data, at step 108, process 100 passes key customer attributes (e.g., customer name, address, phone number, email address, etc.) through a cosine similarity measure for every record in the dataset. Based on a similarity threshold, process 100 returns a dataset of paired customer identifiers that have a similarity above the similarity threshold in one or more of the customer attributes. It can be critical when forming the pairs of customers to avoid pairing records that are logically unlikely to be associated. For example, a customer that is a large global company has different customer attributes than a customer that is an individual person. When creating the pairs, process 100 may avoid checking for similarities of a customer that is identified to not span across multiple regions. For example, while it's very common to find a match on the name “John Smith”, if that name appears in two different regions, it's not likely to be associated with one another. In some implementations, process 100 removes from the dataset paired customer identifiers that span multiple regions.

At step 110, process 100 uses cosine similarity to create the list of paired customer identifiers (e.g., potential matches). Process 100 can create a list of identified paired customer identifiers/features/attributes. Process 100 can create a reduced list of paired customer identifiers that have a cosine similarity value on at least one customer attribute. In some implementations, process 100 performs a coarse pass of the data to identify likely account pairs to be evaluated. Identifying account pairs in the coarse pass can increase the speed of algorithm identifying all the accounts belonging to the same customer.

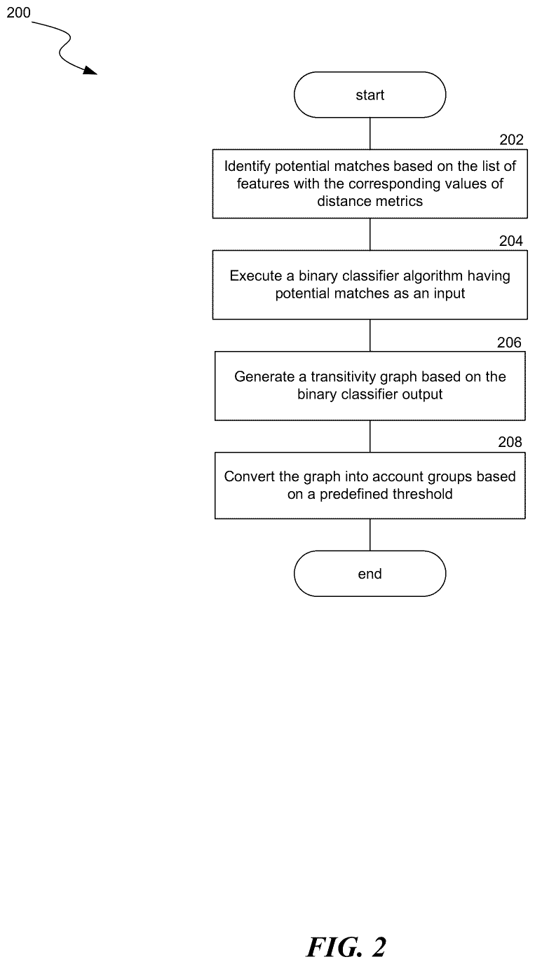

At step 112, process 100 takes the paired customer identifiers/potential matches and calculates the various metrics using the levenshtien distance. Process 100 can calculate a version(s) (simple ratio, partial ratio, token sort ratio, etc.) of the Levenshtein distance on all customer attributes to utilize as features in the binary classification model (step 204 of FIG. 2). For some languages, such as Chinese, Japanese, and Korean, process 100 can translate or use a similarity method that is language specific. For example, with Chinese characters, process 100 uses a matching package “fuzzychinese”, to measure similarity at the character stroke level. Process 100 can reduce the number of record comparisons from the core dataset by performing at least the 2-step (e.g., steps 108 and 110) string similarity procedure with the aim to increase the speed of the association process.

FIG. 2 is a flow diagram illustrating a process 200 used in some implementations for applying a system for customer accounts association in multilingual environments. At step 202, process 200 identifies potential matches of customer data based on the list of features with the corresponding values of distance metrics (e.g., cosine similarity and the various metrics using levenshtien distance (simple ratio, partial ratio, token sort ratio, etc.)). In some implementations, process 200 utilizes a single model to identify the matches of customer data or process 200 utilizes a separate model for each individual region. Utilizing a separate model for a specific region, such as China, can increase model performance. In addition to the distance metrics, process 200 can incorporate various other categorical features that provide classifications about the customer, such as industry, region, or customer type.

At step 204, process 200 executes a binary classifier model (algorithm) having the potential matches as the input. In some cases, due to the nature of the attributes and the scale of the data, process 200 employs LightGBM as the binary classifier. For each pair of customers inputted into the binary classifier model, process 200 outputs a prediction probability of whether the two customer identifiers are associated. In some implementations, the binary classifier algorithm is a gradient boosting machine learning algorithm.

At step 206, process 200 generates a transitivity graph based on the output of the binary classifier model. For example, using the prediction probability returned from the LightGBM model, process 200 utilizes the validated customer pairs as edges in a network. This network is refined to form groups of associated customer identifiers.

At step 208, process 200 converts the transitory graph into account groups based on a predefined threshold. For example, process 200 generates sets of nodes (in our case customer identifiers) for each connected component of the graph. The confidence output of the binary classifier is associated to edges in the graph, while nodes of the graph correspond to the customer accounts. Once a threshold is selected, the edges with confidence lower than the threshold are removed resulting into graph breaking down into a set of smaller graphs (e.g., groups of nodes). The accounts corresponding to nodes in the smaller graph can be considered to belong to the same group of accounts.

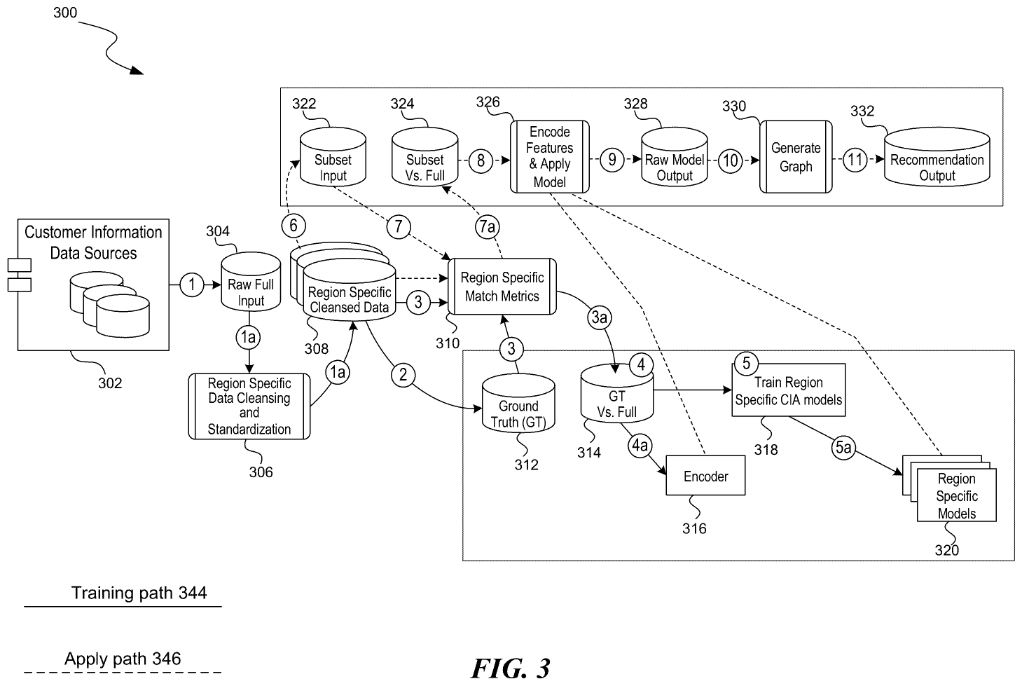

FIG. 3 is a diagram illustrating a customer group creation process according to the present disclosure. The dotted lines illustrate the apply path 346 of the customer group creation process. The solid lines illustrate the training path 344 of the customer group creation process.

At step 1, the raw full input module 304 collects the input data from various sources or technologies, such as customer information data sources 302. At step 1a, the region-specific data cleansing and standardization module 306 cleanses the input data (received from the raw full input module 304) using region specific logic. The region-specific cleansed data module 308 receives the cleansed data from the region-specific data cleansing and standardization module 306.

At step 2, the ground truth (GT) module 312 receives the cleansed data from the region-specific cleansed data module 308 and creates a subset of ground truth records. At step 3, the region-specific match metrics 310 calls the match metrics function with ground truth and full input. The region-specific match metrics 310 receives the cleansed input data from the region-specific cleansed data module 308 and receives the ground truth from the ground truth module 312. At step 3a, the ground truth vs full input data module 314 receives model features generated by a match metric function of the region-specific match metrics 310.

At step 4, the ground truth vs full input data module 314 creates or applies encoders and sends the encoders to the encoder module 316. At step 4a, the encoder module 316 stores the encoders. At step 5, the train region specific models module 318 trains the machine learning model.

At step 5a, region specific models module 320 receives the machine learning model from the train region specific models module 318 and stores the machine learning model. At step 6, the subset input module 322 runs a subset of new or modified records from previous records. The subset input module 322 received the cleansed data from the region-specific cleansed data module 308.

At step 7, the region-specific match metrics module 310 receives the subset of new or modified records from the subset input module 322. At step 7a, the subset vs full input module 324 calls the match metric function with subset input (new and changed data). The subset vs full input module 324 receives the subset data from the region-specific match metrics module 310.

At step 8, the encode features and apply model module 326 encodes the features and applies the model to the encoded features. The encode features and apply model module 326 can retrieve the encoders from the encoder module 316 and retrieve the machine learning model stored in the region-specific models module 320. At step 9, the raw model output module 328 stores the raw output data received from the encode features and apply model module 326.

At step 10, the graph module 330 receives the output data from the raw model output module 328 and generates a graph and refines the graph using model predictions as edges. At step 11, the system creates sets of nodes for each connected component in the graph. In some implementations, recommendations are shown via a user interface which is used to collect feedback (e.g., “truth”). For example, GT set 312 grows over time and is used to periodically retrain the model as well as to monitor model performance.

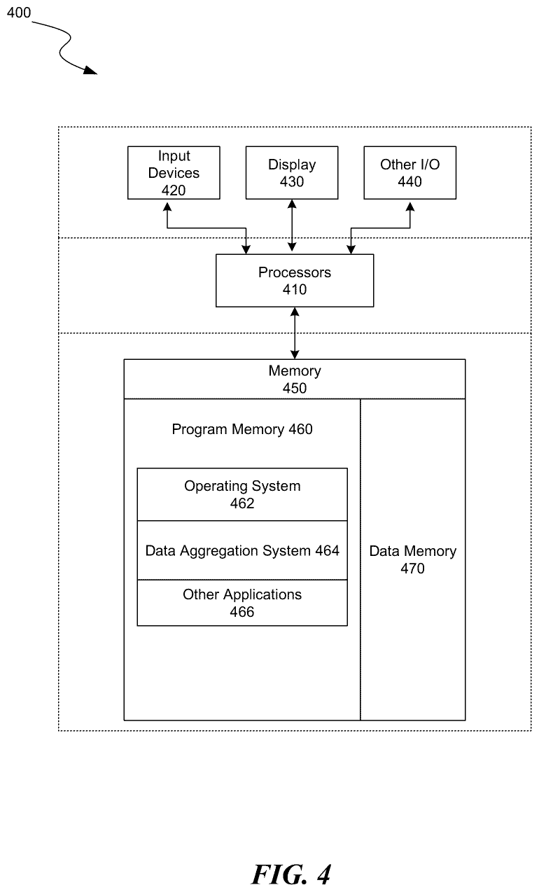

FIG. 4 is a block diagram illustrating an overview of devices on which some implementations of the disclosed technology can operate. The devices can comprise hardware components of a device 400 that manage entitlements within a real-time telemetry system. Device 400 can include one or more input devices 420 that provide input to the processor(s) 410 (e.g., CPU(s), GPU(s), HPU(s), etc.), notifying it of actions. The actions can be mediated by a hardware controller that interprets the signals received from the input device and communicates the information to the processors 410 using a communication protocol. Input devices 420 include, for example, a mouse, a keyboard, a touchscreen, an infrared sensor, a touchpad, a wearable input device, a camera- or image-based input device, a microphone, or other user input devices.

Processors 410 can be a single processing unit or multiple processing units in a device or distributed across multiple devices. Processors 410 can be coupled to other hardware devices, for example, with the use of a bus, such as a PCI bus or SCSI bus. The processors 410 can communicate with a hardware controller for devices, such as for a display 430. Display 430 can be used to display text and graphics. In some implementations, display 430 provides graphical and textual visual feedback to a user. In some implementations, display 430 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 440 can also be coupled to the processor, such as a network card, video card, audio card, USB, firewire or other external device, camera, printer, speakers, CD-ROM drive, DVD drive, disk drive, or Blu-Ray device.

In some implementations, the device 400 also includes a communication device capable of communicating wirelessly or wire-based with a network node. The communication device can communicate with another device or a server through a network using, for example, TCP/IP protocols. Device 400 can utilize the communication device to distribute operations across multiple network devices.

The processors 410 can have access to a memory 450 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 450 can include program memory 460 that stores programs and software, such as an operating system 462, data aggregation system 464, and other application programs 466. Memory 450 can also include data memory 470, storing throttle data, user data, machine data, transmission data, sensor data, device data retrieval data, management data, customer information data, configuration data, settings, user options or preferences, etc., which can be provided to the program memory 460 or any element of the device 400.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

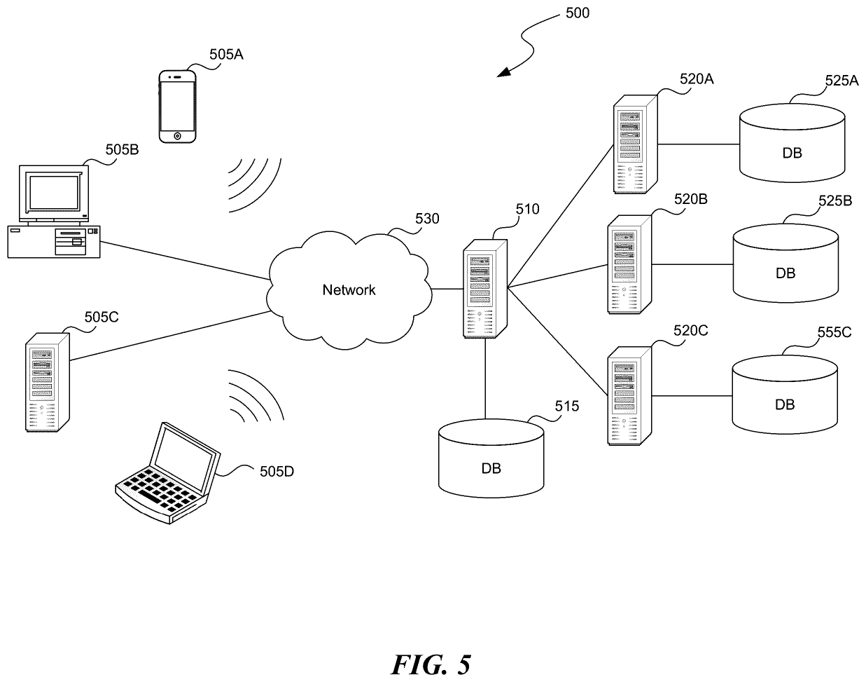

FIG. 5 is a block diagram illustrating an overview of an environment 500 in which some implementations of the disclosed technology can operate. Environment 500 can include one or more client computing devices 505A-D, examples of which can include device 400. Client computing devices 505 can operate in a networked environment using logical connections through network 530 to one or more remote computers, such as a server computing device 510.

In some implementations, server 510 can be an edge server which receives client requests and coordinates fulfillment of those requests through other servers, such as servers 520A-C. Server computing devices 510 and 520 can comprise computing systems, such as device 400. Though each server computing device 510 and 520 is displayed logically as a single server, server computing devices can each be a distributed computing environment encompassing multiple computing devices located at the same or at geographically disparate physical locations. In some implementations, each server 520 corresponds to a group of servers.

Client computing devices 505 and server computing devices 510 and 520 can each act as a server or client to other server/client devices. Server 510 can connect to a database 515. Servers 520A-C can each connect to a corresponding database 525A-C. As discussed above, each server 520 can correspond to a group of servers, and each of these servers can share a database or can have their own database. Databases 515 and 525 can warehouse (e.g. store) information such as implement data, machine data, sensor data, device data, notification data, measurement, and alert data. Though databases 515 and 525 are displayed logically as single units, databases 515 and 525 can each be a distributed computing environment encompassing multiple computing devices, can be located within their corresponding server, or can be located at the same or at geographically disparate physical locations.

Network 530 can be a local area network (LAN) or a wide area network (WAN), but can also be other wired or wireless networks. Network 530 may be the Internet or some other public or private network. Client computing devices 505 can be connected to network 530 through a network interface, such as by wired or wireless communication. While the connections between server 510 and servers 520 are shown as separate connections, these connections can be any kind of local, wide area, wired, or wireless network, including network 530 or a separate public or private network.

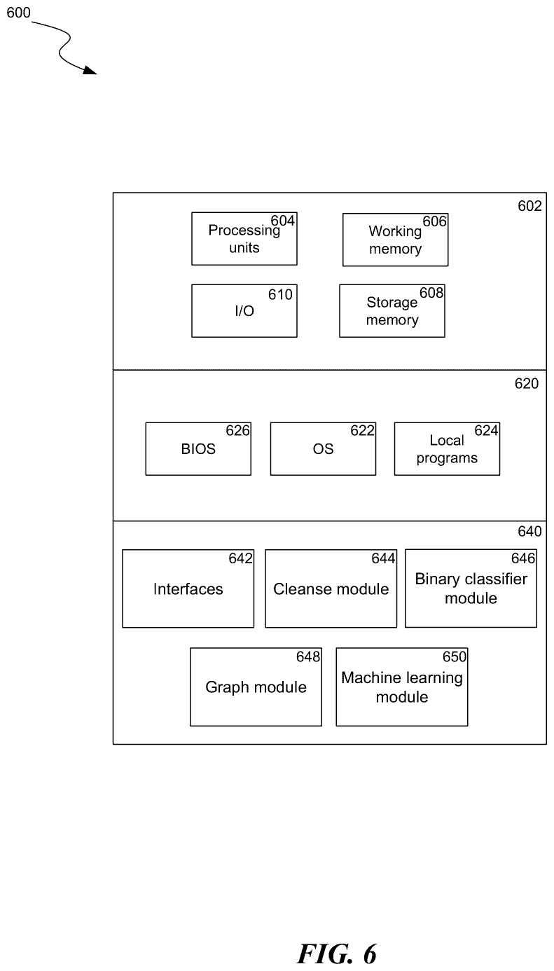

FIG. 6 is a block diagram illustrating components 600 which, in some implementations, can be used in a system employing the disclosed technology. The components 600 include hardware 602, general software 620, and specialized components 640. As discussed above, a system implementing the disclosed technology can use various hardware including processing units 604 (e.g. CPUs, GPUs, APUs, etc.), working memory 606, storage memory 608 (local storage or as an interface to remote storage, such as storage 515 or 525), and input and output devices 610. In various implementations, storage memory 608 can be one or more of: local devices, interfaces to remote storage devices, or combinations thereof. For example, storage memory 608 can be a set of one or more hard drives (e.g. a redundant array of independent disks (RAID)) accessible through a system bus or can be a cloud storage provider or other network storage accessible via one or more communications networks (e.g. a network accessible storage (NAS) device, such as storage 515 or storage provided through another server 520). Components 600 can be implemented in a client computing device such as client computing devices 505 or on a server computing device, such as server computing device 510 or 520.

General software 620 can include various applications including an operating system 622, local programs 624, and a basic input output system (BIOS) 626. Specialized components 640 can be subcomponents of a general software application 620, such as local programs 624. Specialized components 640 can include cleanse module 644, notification module 646, graph module 648, machine learning module 650, and components which can be used for providing user interfaces, transferring data, and controlling the specialized components, such as interfaces 642. In some implementations, components 600 can be in a computing system that is distributed across multiple computing devices or can be an interface to a server-based application executing one or more of specialized components 640. Although depicted as separate components, specialized components 640 may be logical or other nonphysical differentiations of functions and/or may be submodules or code-blocks of one or more applications.

In some embodiments, the cleanse module 644 is configured to cleanse the data with region specific logic to standardize the data across multiple regions. Cleansing and standardizing the data can prevent misleading results. For example, address information does not arrive consistently across regions, such as the order of country, zip code, and street address varies between countries. The cleanse module 644 can parse the regional data to a consistent format and structure that can be used for matching the data with other data. Since the matching process can be sensitive to the length of the strings, the cleanse module 644 can generate a set of abbreviations of commonly used strings. If an example of “Jones Construction Services” and “James Construction Services”, there is similarity between these two strings (e.g., “construction services”), though a human can intuitively know the two strings are not related to the same organization. As such the abbreviation of common strings, such as “Construction Services” provides a pseudo penalty to the matching of longer common strings

In some embodiments, the binary classifier module 646 is configured to execute a binary classifier model (algorithm) having the potential matches as the input. In some cases, due to the nature of the attributes and the scale of the data, the binary classifier module 646 employs LightGBM as the binary classifier. For each pair of customers inputted into the binary classifier model, the binary classifier module 646 outputs a prediction probability of whether the two customer identifiers are associated. In some implementations, the binary classifier algorithm is a gradient boosting machine learning algorithm.

In some embodiments, the graph module 648 is configured generate a transitivity graph based on the output of the binary classifier module 646. For example, using the prediction probability returned from the LightGBM model, the graph module 648 utilizes the validated customer pairs as edges in a network. This network is refined to form groups of associated customer identifiers. The graph module 648 can convert the transitory graph into account groups based on a predefined threshold.

In some embodiments, the machine learning module 650 is configured to identify all the accounts belonging to the same customer based on relevant account information. The machine learning module 650 may be configured to identify account information belonging to the same customer based on at least one machine-learning algorithm trained on at least one dataset of identified information belonging to the same customer. At least one machine-learning algorithm (and models) may be stored locally at databases and/or externally at databases. Customer data grouping devices may be equipped to access these machine learning algorithms and intelligently identify information belonging to a customer based on at least one machine-learning model that is trained on a dataset of identified customer information. As described herein, a machine-learning (ML) model may refer to a predictive or statistical utility or program that may be used to determine a probability distribution over one or more-character sequences, classes, objects, result sets or events, and/or to predict a response value from one or more predictors. A model may be based on, or incorporate, one or more rule sets, machine learning, a neural network, or the like. In examples, the ML models may be located on the client device, service device, a network appliance (e.g., a firewall, a router, etc.), or some combination thereof. The ML models may process customer information databases and other data stores to determine how to identify information belonging to the same customer account.

Based on the customer information from customer information databases and platforms and other user data stores, at least one ML model may be trained and subsequently deployed to automatically identify information belonging to the same customer. The trained ML model may be deployed to one or more devices. As a specific example, an instance of a trained ML model may be deployed to a server device and to a client device which communicate with a machine. The ML model deployed to a server device may be configured to be used by the client device when, for example, the client device is connected to the Internet. Conversely, the ML model deployed to a client device may be configured to be used by the client device when, for example, the client device is not connected to the Internet. In some instances, a client device may not be connected to the Internet but still configured to receive satellite signals with item information, such as specific customer information. In such examples, the ML model may be locally cached by the client device.

Those skilled in the art will appreciate that the components illustrated in FIGS. 4-6 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

### INDUSTRIAL APPLICABILITY

The systems and methods described herein can identify all the accounts belonging to the same customer based on the relevant account information. The association of all accounts belonging to the same customer can be impeded by the use of incorrect, partial, and/or abbreviated relevant account information such as names, customer address, types of industry, and types of fleets. Aggregated customer data from different service providers can allow an original equipment manufacturer (OEM) to better support customers, organize more targeted marketing campaigns for better overall customer experience. In the case that service providers share their customer data with the OEM, the OEM would benefit from aggregating the data from different service providers and aligning it to the customer to build a better and more complete picture of the customer. This will allow the OEM to better support customers, organize more targeted marketing campaigns resulting in better overall customer experience and increased aftermarket profits for both OEM and service providers.

The data aggregation system can utilize a machine learning-based algorithm that identifies all the accounts belonging to the same customer based on relevant account information. Inputs can include customer name, customer address, email, phone number, type of industry, type of fleet, etc. The system utilizes feature creation and a coarse pass to identify likely account pairs. The data aggregation system can perform account association by preparing an input core dataset and updating the core dataset at a predefined time interval with identified new or changed records. The system can reduce the number of record comparisons from the core dataset by performing at least a 2-step string similarity procedure with the aim to increase the speed of the association process. Potential matches are identified based on a list of features with corresponding values of distance metrics. The system can execute a binary classifier algorithm having the potential matches as an input. In some implementations, the system generates a transitivity graph based on the binary classifier output and the graph is converted into account groups based on a predefined threshold. Moreover, the binary classifier algorithm is a gradient boosting machine learning algorithm, and the string similarity procedure comprises execution of at least a cosine similarity and Levenshtein distance procedures.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g. “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

Unless explicitly excluded, the use of the singular to describe a component, structure, or operation does not exclude the use of plural such components, structures, or operations. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

As used herein, the expression “at least one of A, B, and C” is intended to cover all permutations of A, B and C. For example, that expression covers the presentation of at least one A, the presentation of at least one B, the presentation of at least one C, the presentation of at least one A and at least one B, the presentation of at least one A and at least one C, the presentation of at least one B and at least one C, and the presentation of at least one A and at least one B and at least one C.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A computing system comprising:
at least one processor; and
at least one memory storing instructions that, when executed by the at least one processor, cause the computing system to perform a process for customer account association, the process comprising:
preparing a core dataset of input data by:
cleansing the input data with region specific logic to standardize the input data across two or more regions; and
identifying similarity metrics associated with each customer feature in the cleansed input data;
identifying matches in the core dataset based on a list of features of data with corresponding values of the similarity metrics;
executing a binary classifier algorithm with the matches as input to produce a binary classifier output of associated customer identifiers;
creating a transitivity graph based on the binary classifier output of associated customer identifiers; and
converting the transitivity graph into one or more customer account groups based on a similarity threshold.

2. The computing system of claim 1, wherein the process further comprises:
identifying new or changed customer records to add to the core dataset; and
updating at a predefined time interval the core dataset with the identified new or changed records.

3. The computing system of claim 1, wherein the process further comprises:
reducing a number of record comparisons from the core dataset by performing at least a 2-step string similarity procedure,
wherein the 2-step string similarity procedure comprises executing a cosine similarity procedure and a Levenshtein distance procedure.

4. The computing system of claim 1, wherein the process further comprises:
calculating the similarity metrics by:
passing key customer attributes through a cosine similarity procedure for each record in the core dataset; and
based on the similarity threshold, outputting a dataset of paired customer identifiers that have a similarity in one or more of the customer attributes.

5. The computing system of claim 4, wherein the process further comprises:
removing from the dataset at least one paired customer identifier that spans multiple regions.

6. The computing system of claim 1, wherein customer pairs are illustrated as edges in the transitivity graph.

7. The computing system of claim 1, wherein the binary classifier algorithm is a gradient boosting machine learning algorithm.

8. A method for customer account association, the method comprising:
preparing a core dataset of input data by:
cleansing the input data with region specific logic to standardize the input data across two or more regions; and
identifying similarity metrics associated with each customer feature in the cleansed input data;
identifying matches in the core dataset based on a list of features of data with corresponding values of the similarity metrics;
executing a binary classifier algorithm with the matches as input to produce a binary classifier output of associated customer identifiers;
creating a transitivity graph based on the binary classifier output of associated customer identifiers; and
converting the transitivity graph into one or more customer account groups based on a similarity threshold.

9. The method of claim 8, further comprising:
identifying new or changed customer records to add to the core dataset; and
updating at a predefined time interval the core dataset with the identified new or changed records.

10. The method of claim 8, further comprising:
reducing a number of record comparisons from the core dataset by performing at least a 2-step string similarity procedure,
wherein the 2-step string similarity procedure comprises executing a cosine similarity procedure and a Levenshtein distance procedure.

11. The method of claim 8, further comprising:
calculating the similarity metrics by:
passing key customer attributes through a cosine similarity procedure for each record in the core dataset; and
based on the similarity threshold, outputting a dataset of paired customer identifiers that have a similarity in one or more of the customer attributes.

12. The method of claim 11, further comprising:
removing from the dataset at least one paired customer identifier that spans multiple regions.

13. The method of claim 8, wherein customer pairs are illustrated as edges in the transitivity graph.

14. The method of claim 8, wherein the binary classifier algorithm is a gradient boosting machine learning algorithm.

15. A non-transitory computer-readable storage medium comprising: a set of instructions that, when executed by at least one processor, causes the processor to perform operations for customer account association, the operations comprising:
preparing a core dataset of input data by:
cleansing the input data with region specific logic to standardize the input data across two or more regions; and
identifying similarity metrics associated with each customer feature in the cleansed input data;
identifying matches in the core dataset based on a list of features of data with corresponding values of the similarity metrics;
executing a binary classifier algorithm with the matches as input to produce a binary classifier output of associated customer identifiers;
creating a transitivity graph based on the binary classifier output of associated customer identifiers; and
converting the transitivity graph into one or more customer account groups based on a similarity threshold.

16. The non-transitory computer-readable storage medium of claim 15, wherein the operations further comprise:
identifying new or changed customer records to add to the core dataset; and
updating at a predefined time interval the core dataset with the identified new or changed records.

17. The non-transitory computer-readable storage medium of claim 15, wherein the operations further comprise:
reducing a number of record comparisons from the core dataset by performing at least a 2-step string similarity procedure,
wherein the 2-step string similarity procedure comprises executing a cosine similarity procedure and a Levenshtein distance procedure.

18. The non-transitory computer-readable storage medium of claim 15, wherein the operations further comprise:
calculating the similarity metrics by:
passing key customer attributes through a cosine similarity procedure for each record in the core dataset; and
based on the similarity threshold, outputting a dataset of paired customer identifiers that have a similarity in one or more of the customer attributes.

19. The non-transitory computer-readable storage medium of claim 18, wherein the operations further comprise:
removing from the dataset at least one paired customer identifier that spans multiple regions.

20. The non-transitory computer-readable storage medium of claim 15, wherein customer pairs are illustrated as edges in the transitivity graph, and wherein the binary classifier algorithm is a gradient boosting machine learning algorithm.
